(19) United States
(12) Patent Application Publication
(10) Pub. No.: US 2019/0222432 A1
(43) Pub. Date: Jul. 18, 2019

(54) SMART HOUSEHOLD CONTROL METHOD, APPARATUS AND SYSTEM

(71) Applicant: BEIJING VRV SOFTWARE CORPORATION LIMITED, Beijing (CN)

(72) Inventors: Hao LIN, Beijing (CN); Li ZHONG, Beijing (CN)

(21) Appl. No.: 16/246,265

(22) Filed: Jan. 11, 2019

Related U.S. Application Data
(63) Continuation-in-part of application No. PCT/CN2016/000513, filed on Sep. 7, 2016.

(30) Foreign Application Priority Data
Aug. 27, 2016 (CN) 201610744422.9

(51) Int. Cl. H04L 12/28; G10L 15/22

(52) U.S. Cl. CPC H04L 12/282; G10L 15/22; H04L 12/2821; H04L 12/2812

(57) ABSTRACT

A smart household control method, apparatus and system. The method includes: a smart household control apparatus stores configuration information of a smart household device in a control list, the configuration information including a device communication identifier; the apparatus establishes a second connection with a smart household control server after establishing a first connection with the smart household device, so that the smart household control server establishes a communication group including at least one mobile terminal and at least one smart household device, and sends first communication information sent by the at least one mobile terminal in the communication group to the apparatus; and the apparatus receives the first communication information including control information and a communication group identifier and the communication group identifier includes the device communication identifier, the apparatus parses the control information and generates a control instruction, and sends the control instruction to the corresponding smart household device.

### CROSS-REFERENCE TO RELATED APPLICATION

The present disclosure is a continuation-in-part application of an international patent application with the international filing number PCT/CN2016/000513 filed on Sep. 7, 2016, which international application claims priority to Chinese application CN201610744422.9 filed on Aug. 27, 2016, the contents of which are incorporated herein by reference in their entirety.

### TECHNICAL FIELD

The present disclosure relates to the field of smart household, particularly to a smart household control method, apparatus, and system.

### BACKGROUND ART

With the development of technologies of mobile internet and Internet of Things, people will be able to interact with their smart household devices no matter where they are. For a smart household, various devices (such as audio and video devices, lighting systems, curtain control, air conditioning control, security systems, digital cinema systems, audio and video servers, video cabinet systems, and network appliances) in the home are connected together substantially using the technology of Internet of Things, to provide a plurality of functions and means such as appliance control, lighting control, telephone remote control, indoor and outdoor remote control, burglar alarm, environmental monitoring, heating and ventilation control, infrared repeater, and programmable timing control. Compared with a common home household, the smart household not only has the conventional function for dwelling, but also possesses functions for building, network communication, information appliances, device automation, and providing all-around information interactions, and the smart household even can also economize money on a variety of energy charges.

In recent years, smart household robot technologies and corresponding products emerge one after another, and the smart household robot can be used as a module of a smart hardware device or appliance for controlling various smart household devices. However, the control of the smart household robot over the smart household devices still stays on an outdated instruction level of control, with a quite simple interaction mode with the household devices, while smart characteristics of the smart household devices are more embodied in an addition of various sensors to these devices, such as temperature sensors and distance sensors.

### SUMMARY

In view of this, some embodiments of the present disclosure provide a smart household control method, apparatus, and system, so as to strive to alleviate at least one of the foregoing existing problems.

The present disclosure provides a smart household control method, the method comprising:

a smart household control apparatus storing configuration information of at least one smart household device in a control list, wherein the configuration information of each of the at least one smart household device comprises a device communication identifier;

the smart household control apparatus establishing a second connection with a smart household control server, after the smart household control apparatus establishes a first connection with each of the at least one smart household device, such that the smart household control server establishes a communication group comprising at least one mobile terminal and at least one smart household device, and sends first communication information sent from the each of the at least one mobile terminal and received in the communication group, to the smart household control apparatus; and

receiving the first communication information, wherein the first communication information comprises control information and a communication group identifier and the communication group identifier comprises the respective device communication identifier, parsing the control information and generating a control instruction, and sending the control instruction to the respective smart household device,

wherein each of the at least one smart household device sends its own status information to the smart household control apparatus after executing the control instruction, the smart household control apparatus converts the status information to second communication information and sends the second communication information to the smart household control server, and the smart household control server sends the second communication information to a communication group corresponding to the respective communication group identifier.

The present disclosure provides a smart household control apparatus, the apparatus comprising:

an information storage module, configured to store configuration information of at least one smart household device in a control list, wherein the configuration information of each of the at least one smart household device comprises a device communication identifier;

a communication module, configured to make the smart household control apparatus establish a second connection with a smart household control server after the smart household control apparatus establishes a first connection with each of the at least one smart household device, such that the smart household control server establishes a communication group comprising at least one mobile terminal and at least one smart household device, and send first communication information sent from each of the at least one mobile terminal and received in the communication group to the smart household control apparatus; and

an instruction processing module, configured to receive the first communication information, wherein the first communication information comprises control information and a communication group identifier, and the communication group identifier comprises the respective device communication identifier, parse the control information and generate a control instruction, and send the control instruction to a corresponding smart household device,

wherein the smart household device sends its own status information to the smart household control apparatus after executing the control instruction, the smart household control apparatus converts the status information to second communication information and sends the second communication information to the smart household control server, and the smart household control server sends the second communication information to a communication group corresponding to the communication group identifier.

The present disclosure provides a smart household control system, the system comprising: at least one mobile terminal, at least one smart household device, a smart household control server, and the foregoing smart household control apparatus,

wherein each of the at least one mobile terminal is configured to send first communication information to the smart household control server,

the smart household control server establishes a communication group comprising at least one mobile terminal and at least one smart household device, and sends to the smart household control apparatus the first communication information sent from each of the at least one mobile terminal and received in the communication group.

In order to make the above objects, features, and advantages of the present disclosure more apparent and understandable, preferred embodiments are particularly illustrated below in cooperation with attached accompanying drawings to make following detailed description.

### BRIEF DESCRIPTION OF DRAWINGS

In order to more clearly illustrate technical solutions of embodiments of the present disclosure, accompanying drawings which are needed for the embodiments will be introduced briefly below. It should be understood that the accompanying drawings below merely show some embodiments of the present disclosure, therefore, they should not be considered as limiting the scope, and a person ordinarily skilled in the art still can obtain other relevant accompanying drawings according to these accompanying drawings, without using inventive efforts.

FIG. 1 shows a schematic diagram of a smart household control system provided in an embodiment of the present disclosure;

FIG. 2 shows a flow chart of a smart household control method provided in an embodiment of the present disclosure; and

FIG. 3 shows a structural schematic diagram of a smart household control apparatus provided in an embodiment of the present disclosure.

FIG. 4 schematically shows an electronic device implementing major structures of certain mobile terminals, smart household control servers, smart household control apparatus, and smart household devices according to certain aspects of the present disclosure.

### DETAILED DESCRIPTION OF EMBODIMENTS

In order to make objects, technical solutions, and advantages of the embodiments of the present disclosure clearer, the technical solutions in the embodiments of the present disclosure will be described clearly and completely below in conjunction with accompanying drawings in the embodiments of the present disclosure. Apparently, some but not all embodiments of the present disclosure are described. Generally, components in the embodiments of the present disclosure, as described and shown in the accompanying drawings herein, may be arranged and designed in various different configurations. Therefore, the detailed description below of the embodiments of the present disclosure provided in the accompanying drawings is not intended to limit the scope of the present disclosure claimed, but merely illustrates chosen embodiments of the present disclosure. All other embodiments obtained by a person skilled in the art based on the embodiments of the present disclosure without inventive efforts shall fall within the scope of protection of the present disclosure.

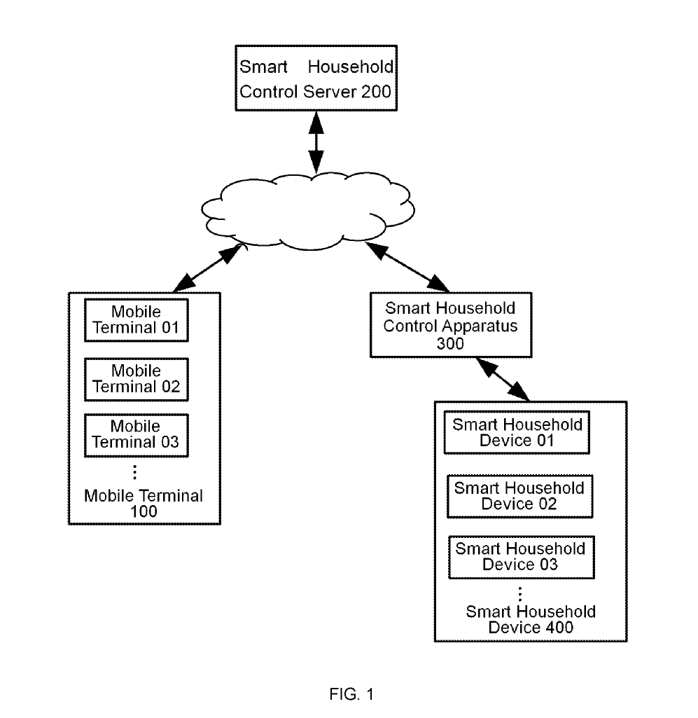

FIG. 1 shows a structural diagram of a smart household control system according to some embodiments of the present disclosure. As shown in FIG. 1, the smart household control system for accessing comprises: at least one mobile terminal 100, a smart household control server 200, a smart household control apparatus 300, and at least one smart household device 400.

The smart household control system in the present disclosure can help a user establish an intelligent smart household control network, and the user, no matter at home or in an office, can manipulate smart household devices efficiently and conveniently in a personified manner by using the network. The system generally comprises at least one mobile terminal 100 (e.g. mobile terminal 01, mobile terminal 02, mobile terminal 03 and so on) and at least one smart household device 400 (smart household device 01, smart household device 02, smart household device 03 and so on). The above at least one mobile terminal 100 may be in various types, such as portable mobile devices like a smart cellphone, a tablet computer, a smart bracelet, etc. An instant communication application software or client (APP) for controlling the at least one smart household device may be installed on each of the at least one mobile terminal 100. The at least one smart household device 400 may include, but is not limited to, various intelligent devices such as smart furniture (e.g. smart cabinet, smart bed, and smart door and window), smart appliances (e.g. smart television, smart air conditioner, and smart lighting device), smart security devices (e.g. smart camera, smart controlled gating), smart automobile, and smart drone. It can be understood that the above types of the smart household devices are merely for exemplary illustration, and are not limited herein. Each of the at least one smart household device 400 is provided therein with a network connection module, wherein the network connection module may comprise a wired network connection unit and/or a wireless network connection unit, such that the respective smart household device can be connected to the smart household control apparatus 300 in a wired mode (e.g. optical fiber) or a wireless mode (e.g. WIFI, bluetooth, 3G, and 4G). The smart household control apparatus 300 also may be called as an access control device or gateway. In some embodiments, it may be a portable device, for example, it may be implemented as a part of a small-size portable (or mobile) electronic device. These electronic devices may be, such as, smart router, set-top box, game console, personal media player device, wireless network browsing device, application-specific device, or a hybrid device that may be provided with any of the above functions. After the at least one smart household device 400 is connected with the smart household control apparatus 300, the smart household control apparatus 300 registers an account for each accessed smart household device 400, and logs the above accounts in to the smart household control server 200, wherein the smart household control server 200 is in communication connection with the at least one mobile terminal 100, and communication between the at least one mobile terminal 100 and the at least one smart household device 400 can be realized by the smart household control apparatus 300 and the smart household control server 200. The smart household control server 200 mostly serves for realizing information sending and reception. However, it should be understood herein that the present disclosure is not limited by the functions or types of the server, and all servers that may realize the functions of the smart household control server in the present disclosure fall within the scope of protection of the present disclosure. Detailed description is made below.

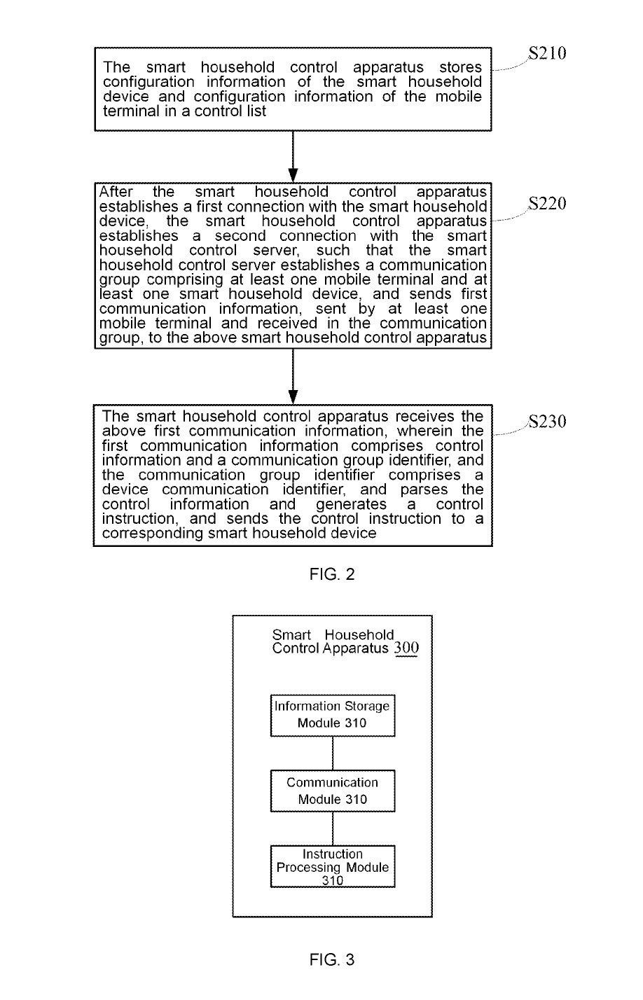

FIG. 2 shows a flow chart of a smart household control method provided in one embodiment of the present disclosure. As illustrated in FIG. 2, the smart household control method is implemented by a smart household control apparatus, and in some embodiments, reference can be made to Step S210-Step S230 for the method.

In Step S210, the smart household control apparatus stores configuration information of the at least one smart household device and configuration information of the at least one mobile terminal in a control list, wherein the configuration information of each of the at least one smart household device may include information on the respective device such as device communication identifier and device attribute information, and the configuration information of each of the at least one mobile terminal may include user information such as user account information and user communication identifier, wherein the device communication identifier may be directly used for representing an instant communication account of smart household, or is associated with the instant communication account of smart household.

Firstly, an administrator may configure the smart household control apparatus from a computing device such as a computer, for example, an administrator may enter attribute information of the smart household device that needs to be controlled and so on. The attribute information may include the smart household device's type, name, model, device function, installation position, network MAC address among others. Taking a smart air conditioner as an example, attribute information of the smart air conditioner entered into the smart household control apparatus comprises air conditioner, Haier, KFR-35GW/15DEA22AU1, cooling/heating/dehumidification, living room and so on.

The smart household control apparatus allocates a device communication identifier for each smart household device whose attribute information is entered. The device communication identifier may be a random code. The identifier of each smart household device is unique, and also may be called as a communication identifier of the respective smart household device. On the smart household control apparatus, one instant communication account of smart household is registered for each smart household device. Information on the instant communication account of smart household may include information such as account name and password. On the smart household control apparatus, each instant communication account of smart household further may be bound with a corresponding device communication identifier.

After having registered the information of the smart household device on the smart household control apparatus, the administrator registers, for example, configuration information of a mobile terminal (the configuration information of the mobile terminal may include user communication identifier, user account information, login user name and so on) of a family user, on the smart household control apparatus, and stores in the control list a setting concerning whether the user is allowed to operate the smart household device. According to an embodiment, the user communication identifier for example is a serial number of a mobile terminal device or a user account. The user communication identifier also exists uniquely. However, it should be understood herein that the user communication identifier is not limited to the serial number of the mobile terminal device, and all identifiers that can differentiate among users uniquely are within the scope of protection of the present disclosure.

The administrator may set in the control list whether each user is allowed to control the smart household device. A structure of the control list for example may be: <User Communication Identifier, User Account, Device Communication Identifier, Instant Communication Account of Smart Household, Action (Allowed or Not Allowed)>. For example, a user A can control the smart air conditioner, but is not allowed to control the smart television, correspondingly, “Allowed” and “Not Allowed” are in corresponding action bars in the control list respectively.

In Step S220, after the smart household control apparatus establishes a first connection with each of the at least one smart household device, the smart household control apparatus establishes a second connection with the smart household control server, such that the smart household control server establishes a communication group comprising at least one mobile terminal and at least one smart household device, and sends first communication information, sent from each of the at least one mobile terminal and received in the communication group, to the above smart household control apparatus. In the above, the first connection generally comprises a wireless (WIFI) connection and/or a wired connection, and the second connection may be a network connection such as a TCP (Transmission Control Protocol) connection. The above smart household control server and the mobile terminal are generally connected wirelessly.

After the at least one smart household device is connected with the smart household control apparatus in a wireless or a wired mode, the smart household control apparatus logs in to the smart household control server using the information of the instant communication account of the respective smart household device, such that each of the at least one smart household device becomes an on-line robot.

The user may request to add one or more robots (that is, the smart household device or the smart household devices) as friend or friends by using each of the at least one mobile terminal. After receiving the friend adding request from the respective mobile terminal, the smart household control server will inquire the setting recorded in the control list stored in the smart household control apparatus, which setting determines whether the user is allowed to operate the respective smart household device(s) that the user requests to be added as friend(s). If the control list shows that the user is allowed to operate the smart household device(s), the smart household control server determines that the user's application for adding the smart household device(s) as friend(s) that the user requests is successful, and after the user successfully adds the smart household device(s) as friend(s), the above user further can establish by using the smart household control server a communication group which may include at least one user and at least one smart household device, that is, in some embodiments, multiple users and multiple smart household devices may be included. Taking an example in which the user A requesting to add a robot B corresponding to the smart air conditioner as a friend, the user A sends a friend request to the server using the respective mobile terminal, which request carries device information such as communication identifier of the smart household device to be added as friend; after receiving the request, the server inquires the control list of the smart household control apparatus to determine whether the user A is allowed to operate the smart air conditioner corresponding to the robot B. If the user A is allowed to operate, the user A and the robot B become friends. Apart from being capable of adding a robot as a friend, the user also may establish friendship with other users, and establish a communication group, and add other users and robots having friendship with the user per se to a same communication group. For example, a user A1 submits a friend application to the server using the respective mobile terminal, and after being accepted by a user A2, the user A1 establishes friendship with the user A2. The user A1 and a robot B1 are friends, and are in a communication group 1, then the user A1 further may add the user A2 to the communication group 1, such that the user A2 and the robot B1 exchange information by the communication group 1. Besides, assume that the user A2 and the robot B2 are friends, the user A2 even may add the robot B2 to the communication group 1, such that the user A1 and the robot B2 exchange information therebetween. In this manner, great convenience are given to group of users, which enables various family members in the family, or various colleagues in an office to exchange information and control smart households more conveniently.

After the communication is established between the at least one mobile terminal and the at least one smart household device on the smart household control server, each of the at least mobile terminal may be displayed to the user in a form of chat window. The chat windows may be for one-to-one chat, and also may be a group type chat window. The user inputs text information or voice information in the chat windows. Each of the at least one mobile terminal sends first communication information comprising the above voice information, to the smart household control server. The smart household control server further sends the above first communication information to the smart household control apparatus. That is, the first communication information is information received from the user via the chat window displayed on an interface of the respective mobile terminal.

Next, in Step S230, the smart household control apparatus receives the above first communication information, wherein the first communication information may include control information and a communication group identifier, and the communication group identifier comprises the device communication identifier, and the smart household control apparatus parses the control information and generates corresponding control instruction, and sends the control instruction to a corresponding smart household device.

After receiving the first communication information sent by the smart household control server, the smart household control apparatus converts the control information (e.g. voice information) in the first communication information and generates control instruction that can be identified by the at least one smart household device, for example, the control instruction may be represented in a form of digit, character and so on, then members of the communication group are identified according to the communication group identifier in the first communication information. The communication group generally comprises at least one user and at least one smart household device account (which may be associated with the respective device communication identifier). According to an embodiment, the smart household control apparatus inquires the control list, according to the communication group identifier and the device communication identifier, to determine whether a user corresponding to the above user communication identifier is allowed to operate the respective smart household device in the user group (which may be understood as the communication group). If the user sending the information is allowed to operate the respective smart household device in the user group, the above control instruction is sent to the smart household device in the user group that the user is allowed to operate. In the above, the first communication information is text information and/or voice information expressed in a manner of natural language.

After executing the above control instruction, the smart household device sends its own status information to the smart household control apparatus, the smart household control apparatus converts the status information to second communication information and sends the second communication information to the smart household control server, and the smart household control server sends the second communication information to a communication group corresponding to the respective communication group identifier, wherein the second communication information is text information and/or voice information expressed in a manner of natural language, generally comprising operation status information and execution information of the smart household device itself.

In order to facilitate understanding, exemplary description is as follows: in some embodiments, the user A and a smart air conditioner robot undertake a point-to-point chat. The user A inputs the first communication information “Turn on the air conditioner, cooling mode, temperature 26° C.” in an voice or text form from the mobile terminal. After receiving the above information, the smart household control server sends the above information to the smart household control apparatus which parses the above information, and generates control instruction that can be identified by the respective smart household device, and sends the control instruction to the smart air conditioner. After executing the instruction, the smart air conditioner sends its own status information “Air conditioner turned on, cooling mode, set temperature 26° C.” to the smart household control apparatus. The smart household control apparatus further converts the status information fed back by the smart air conditioner to the second communication information, for example, the converted second communication information may be “Master, I am working perfectly. Cooling mode is already on. The temperature is set to 26° C. If you still feel it's hot, please tell me!” Then, the second communication information is sent to the smart household control server, by which the second communication information is sent to the respective mobile terminal. The above information is further displayed to the user A via the chat window of the mobile terminal.

In some other embodiments, multiple users and multiple smart household device robots undertake a group chat. The group comprises the user A1, the user A2, and a user A3, and the smart household devices include smart air conditioner, smart television, and smart lighting device. At this time, the user A1 inputs “Turn on the air conditioner, cooling mode, temperature 26° C.” in the chat window, the user A2 inputs “Turn on the television, switch to channel CCTV1”, and the user A3 inputs “Turn on the lighting device”. The server sends the above received information to the smart household control apparatus, which parses each piece of the received information, correspondingly generates corresponding control instruction, and searches in the control list, according to the user communication identifier and the device communication identifier in each piece of information, to determine whether the user is allowed to control the smart household devices in question, for example, by using the control list, to judge whether the user A1 is allowed to control the smart air conditioner, to judge whether the user A2 is allowed to control the smart television, and to judge whether the user A3 is allowed to control the smart lighting device. If the users A1, A2, and A3 are respectively allowed to control corresponding smart devices, the smart air conditioner, the smart television, and the smart lighting device execute corresponding control instructions. After the corresponding smart household devices execute the control instructions respectively received, to the smart household control apparatus, the smart air conditioner returns its own status information “Air conditioner turned on, cooling mode, set temperature 26° C.”, the smart television returns its own status information “Smart television turned on, switched to channel XX”, and the smart lighting device returns its own status information “Smart lighting device turned on”. The smart household control apparatus further sends the status information of the above respective smart household devices to the smart household control server, and the robot accounts in the smart household control server which correspond to respective devices return corresponding information to respective mobile terminals.

In some other embodiments, the smart household control apparatus searches in the control list, according to the received status information of the smart household device, for the smart household device associated with the above smart household device, and sends a preset control instruction to a found smart household device, such that the found smart household device executes the preset control instruction, and returns its own status information after the execution to the smart household control apparatus, wherein the control list further comprises a smart household device associated with the smart household device, for example, a smart curtain associated with the smart lighting device, smart door and window associated with the smart air conditioner and so on.

In order to facilitate understanding, exemplary description is as follows: in some embodiments, similarly, multiple users and multiple smart household device robots undertake a group chat. The group comprises the user A1, the user A2, and the user A3, and the smart household devices include the smart curtain, the smart television, and the smart lighting device. When receiving information “Turn on the light” returned from the smart lighting device, the smart household control apparatus searches in the control list for a device associated with the smart lighting device, such as the smart curtain, and the smart household control apparatus sends a preset control instruction to the smart curtain, for example, “Close the smart curtain”. After executing the above control instruction, the smart curtain sends status information “Smart curtain closed” to the smart household control apparatus. The smart household control apparatus transmits the information of the smart lighting device and the smart curtain to the smart household control server, which sends the above status information to various members in the communication group.

Besides, the smart household device is further configured to: sense, in one communication group, third communication information of intro-group members, initiatively execute a related operation according to the third communication information, and return its own status information after the execution to the communication group, wherein the third communication information may be information exchanged in the communication group among the intra-group users, and certainly, also may include the first communication information and/or the second communication information of the respective smart household device robots within the group.

For example, in some other embodiments, similarly multiple users and multiple smart household device robots undertake a group chat. The group comprises the user A1, the user A2, and the user A3, and the smart household devices include the smart air conditioner and the smart television. In this embodiment, the smart household devices are capable of initiatively sensing the communication information of the members of the communication group and adopting an initiative operation. When the user A1, the user A2, and the user A3 talk about that they want to watch television because World Cup Football Game will be broadcast live right away on television channel XX, the smart television will sense the communication information among the users, thus initiatively turns on the television, and switches to the channel XX, and then feeds back its own status information to the users. Further, when the user A1, the user A2, and the user A3 talk about that it is a little too hot in a room, the smart air conditioner also will sense the communication information among the users, thus initiatively turns on the air conditioner, and sets a comfortable temperature and air volume, and then feeds back its own status information to the users.

According to the technical solutions of the present disclosure, the users configure the smart household control apparatus, such that the at least one smart household device is connected to the smart household control apparatus via the network, to enable each of the at least one smart household device to become an independent account, thereby achieving an object of smart interaction between smart household devices and users, then the users can control the smart household devices more conveniently.

FIG. 3 shows a structural schematic diagram of the smart household control apparatus provided in one embodiment of the present disclosure. As shown in FIG. 3, the smart household control apparatus (i.e. smart household control apparatus) comprises: an information storage module 310, a communication module 320, and an instruction processing module 330.

The information storage module 310 is configured to store configuration information of at least one smart household device in the control list. The configuration information of each of the at least one smart household device comprises a device communication identifier. The configuration information of each of the at least one smart household device comprises information on the respective instant communication account of smart household. In the above, the configuration information of each of the at least one smart household device comprises the respective device communication identifier. The control list further comprises setting of whether a user is allowed to operate the respective smart household device.

The communication module 320 is configured to establish a second connection between the smart household control apparatus and the smart household control server after the smart household control apparatus establishes a first connection between the smart household control apparatus and each of the at least one smart household device, such that the smart household control server establishes a communication group comprising at least one mobile terminal and at least one smart household device, and sends the first communication information sent from each of the at least one mobile terminal and received in the communication group, to the smart household control apparatus.

The instruction processing module 330 is configured to receive the first communication information, wherein the first communication information comprises control information and the communication group identifier, and the communication group identifier comprises the device communication identifier; to parse the control information and generate the control instruction; and to send the control instruction to a corresponding smart household device. After executing the control instruction, the smart household device sends its own status information to the smart household control apparatus, which converts the status information to the second communication information and sends the second communication information to the smart household control server, and the smart household control server sends the second communication information to a communication group corresponding to the communication group identifier. In the above, the first communication information further comprises the user communication identifier, and the communication group corresponding to the communication group identifier comprises at least one user and at least one smart household device.

According to some embodiments, the instruction processing module inquires the control list, according to the user communication identifier and the communication group identifier, to determine whether a user corresponding to the user communication identifier is allowed to operate the respective smart household device in the communication group, and the instruction processing module sends the control instruction to the smart household device in the communication group that the user is allowed to operate.

According to some embodiments, the instruction processing module searches in the control list, according to the received status information of the smart household device, for a smart household device associated with the above smart household device, and sends preset control instruction to a found smart household device, such that the found smart household device executes the preset control instruction, and returns its own status information after the execution to the smart household control apparatus.

The smart household control apparatus provided in the embodiment of the present disclosure may be specific hardware on a device or software, firmware or the like installed on a device. The apparatus provided in the embodiment of the present disclosure has the same implementation principle of and technical effects produced as those in the preceding method embodiment, and for the sake of concise description, reference can be made to corresponding contents in the preceding method embodiment for contents which are not mentioned in the part of the apparatus embodiment. A person skilled in the art can clearly know that for the sake of convenience and conciseness, reference can be made to corresponding processes in the above method embodiment for specific operation processes of the system, apparatus, and units described in the preceding, and they will not be repeated redundantly herein.

On the basis of the above smart household control apparatus, the main operation principle of the smart household control system can be illustrated further in combination with FIG. 1. In the above, the at least one mobile terminal is configured to send the first communication information to the smart household control server. The smart household control server establishes the communication group comprising at least one mobile terminal and at least one smart household device, and sends the first communication information sent from each of the at least one mobile terminal and received in the communication group, to the smart household control apparatus.

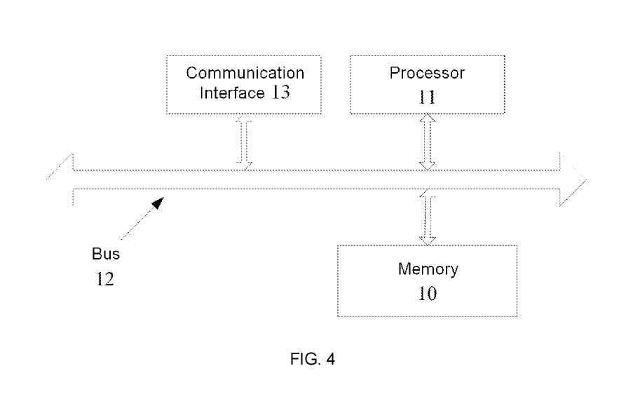

In some embodiments, each of the at least one smart household device is configured to: execute the control instruction sent by the smart household control apparatus, and send its own status information to the smart household control apparatus. The smart household control apparatus converts the status information to the second communication information and sends the second communication information to the smart household control server, which sends the second communication information to a communication group corresponding to the communication group identifier. In some other embodiments, the at least one smart household device is further configured to: sense in one communication group the third communication information of intra-group members, and initiatively execute a related operation according to the third communication information, and return its own status information after the execution, to the communication group. The present embodiment further provides a structural schematic diagram of an electronic device. Main structures of all of the mobile terminals, the smart household control servers, the smart household control apparatus, and the smart household devices mentioned in the present embodiment may be implemented with reference to the structure of this electronic device. Specifically as shown in FIG. 4, the electronic device comprises a memory 10 and a processor 11, wherein the memory 10 is configured to store one or more pieces of machine readable instruction which is executed by a processor, so as to realize the above smart household control method.

Further, the electronic device shown in FIG. 4 further comprises a bus 12 and a communication interface 13, and the processor 11, the communication interface 13, and the memory 10 are connected via the bus 12.

In the above, the memory 10 may include high-speed Random Access Memory (RAM), and also may include non-volatile memory, for example, at least one disk memory. Communication connection between this system network element and at least one other network element is achieved by at least one communication interface 13 (possibly wired or wireless), and Internet, Wide Area Network, local network, Metropolitan Area Network and so on may be used. The bus 12 may be an ISA bus, a PCI bus, or an EISA bus and so on. The bus may be an address bus, a data bus, a control bus and so on. For ease of representation, the bus is represented merely with one two-way arrow in FIG. 4, but it does not mean that there is only one bus or one type of bus.

The processor 11 possibly is an integrated circuit chip, provided with a signal processing function. In an implementation process, various steps of the above method may be achieved by an integrated logic circuit of hardware in the processor 11 or instruction in a software form. The above processor 11 may be a general-purpose processor, including a Central Processing Unit (“CPU” for short), a Network Processor (“NP” for short), etc., and also may be a Digital Signal Processor (DSP), an Application Specific Integrated Circuit (“ASIC” for short), a Field-Programmable Gate Array (“FPGA” for short) or other programmable logic devices, discrete gates, transistor logic devices, or discrete hardware components that can realize or implement various methods, steps, and logic blocks disclosed in the embodiments of the present disclosure. The general-purpose processor may be a microprocessor or the processor also may be any conventional processor and so on. The steps of the method disclosed in the embodiments of the present disclosure may be directly embodied as being executed and achieved by hardware decoding processor, or executed and achieved by hardware and software modules in combination in a decoding processor. The software module may be located in a mature storage medium in the art such as a random access memory, a flash memory, a read-only memory, a programmable read-only memory or electrically erasable programmable memory, and a register. The storage medium is located in the memory 10. The processor 11 reads information in the memory 10, and in combination with hardware thereof, achieves the steps of the method of the preceding embodiment.

In the embodiments provided in the present disclosure, it should be understood that the apparatus and the method disclosed may be implemented in other manners. The apparatus embodiment described in the above is merely exemplary, for example, the units are merely divided according to logical functions, but they may be divided in other manners in practical implementation, for another example, multiple units or components may be combined or may be integrated into another system, or some features may be omitted, or not executed. In addition, mutual couplings or direct coupling or communication connection as shown or discussed may be indirect coupling or communication connection via some communication interfaces, means or units, and may be in an electrical form, a mechanical form or other forms.

The said units described as separate parts may be or also may not be physically separated, the parts displayed as units may be or also may not be physical units, i.e., they may be located at one place, or also may be distributed on a plurality of network units. The object of the solution of the present embodiment may be realized by selecting part or all of the units thereof as actually required.

Besides, various functional units in the embodiments of the present disclosure may be integrated into one processing unit, or each unit also may exist in a physically independent way, and two or more than two units also may be integrated into one unit.

If the function is realized in a form of software functional unit and is sold or used as an individual product, it may be stored in one computer readable storage medium. Based on such understanding, the technical solutions in essence or parts making contribution to the prior art or parts of the technical solutions of the present application can be embodied in form of a software product, and this computer software product is stored in a storage medium, comprising several instructions for causing one computer device (which can be a personal computer, a server or a network device etc.) to execute all or part of the steps of the methods of various examples of the present application. The aforementioned storage medium comprises various media in which program codes can be stored, such as U disk, mobile hard disk, Read-Only Memory (ROM), Random Access Memory (RAM), diskette and compact disk.

It should be noted that similar reference signs and letters represent similar items in the following accompanying drawings, therefore, once a certain item is defined in one accompanying drawing, it is not needed to be further defined or explained in subsequent accompanying drawings. Besides, terms such as “first”, “second”, and “third” are merely for distinctive description, but should not be construed as indicating or implying relative importance.

Finally, it should be indicated that the embodiments above are merely for specific embodiments of the present disclosure, for illustrating the technical solutions of the present disclosure, rather than limiting the present disclosure. The scope of protection of the present disclosure should not be limited thereto. While the detailed description is made to the present disclosure with reference to the above-mentioned embodiments, those ordinarily skilled in the art should understand that the technical solutions recited in the above-mentioned embodiments still can be modified, or readily changed, or equivalent substitutions can be made to some of the technical features therein by any person familiar to the art within the technical scope disclosed in the present disclosure; these modifications, changes, or substitutions do not make the corresponding technical solutions essentially depart from the spirit and scope of the technical solutions of the embodiments of the present disclosure. They all should be covered within the scope of protection of the present disclosure. Therefore, the scope of protection of the present disclosure should be based on the scope of protection of the claims.

### INDUSTRIAL APPLICABILITY

With the application of the technical solutions of the present disclosure, the smart interaction between smart household devices and users can be realized, which enables the users to control the smart household devices more conveniently.

What is claimed is:

1. A smart household control method, comprising steps of:
a smart household control apparatus storing configuration information of at least one smart household device in a control list, wherein the configuration information of each of the at least one smart household device comprises a device communication identifier;
the smart household control apparatus establishing a second connection with a smart household control server after establishing a first connection with the at least one smart household device, such that the smart household control server establishes a communication group comprising at least one mobile terminal and at least one smart household device and sends first communication information, which is sent from each of the at least one mobile terminal and received in the communication group, to the smart household control apparatus; and
receiving the first communication information, wherein the first communication information comprises control information and a communication group identifier, and the communication group identifier comprises the device communication identifier, parsing the control information and generating a control instruction, and sending the control instruction to a corresponding smart household device,
wherein the smart household device sends its own status information to the smart household control apparatus after executing the control instruction, the smart household control apparatus converts the status information to second communication information and sends the second communication information to the smart household control server, and the smart household control server sends the second communication information to a communication group corresponding to the communication group identifier.

2. The smart household control method according to claim 1, wherein the first communication information and the second communication information are text information and/or voice information expressed in a manner of natural language.

3. The smart household control method according to claim 2, wherein the first communication information is received from a user via a chat window displayed on an interface of the respective mobile terminal.

4. The smart household control method according to claim 1, wherein the control list further comprises setting of whether the user is allowed to control the respective smart household device.

5. The smart household control method according to claim 1, wherein the first communication information further comprises a user communication identifier, and the communication group corresponding to the communication group identifier comprises at least one user and at least one smart household device.

6. The smart household control method according to claim 1, wherein the step of sending the control instruction to a corresponding smart household device further comprises:
inquiring the control list, according to a user communication identifier and the communication group identifier, to determine whether a user corresponding to the user communication identifier is allowed to operate the respective smart household device in the communication group, and sending the control instruction to a smart household device in the communication group that the user is allowed to operate.

7. The smart household control method according to claim 1, further comprising:
the smart household control apparatus searching in the control list for a smart household device associated with the smart household device according to the received status information of the smart household device, and sending a preset control instruction to a found smart household device, such that the found smart household device executes the preset control instruction, and returns its own status information after execution, to the smart household control apparatus.

8. The smart household control method according to claim 1, wherein the method further comprises:
the at least one smart household device sensing, in one communication group, third communication information of members in the communication group, and initiatively executing a related operation according to the third communication information, and returning its own status information after execution, to the communication group.

9. A smart household control apparatus, wherein the apparatus comprises:
an information storage module, configured to store configuration information of at least one smart household device in a control list, wherein the configuration information of each of the at least one smart household device comprises a device communication identifier;
a communication module, configured to establish a second connection between a smart household control apparatus and a smart household control server after establishing a first connection between the smart household control apparatus and the at least one smart household device, such that a communication group comprising at least one mobile terminal and at least one smart household device is established by the smart household control server, to send first communication information, sent from each of the at least one mobile terminal and received in the communication group, to the smart household control apparatus; and
an instruction processing module, configured to receive the first communication information, wherein the first communication information comprises control information and a communication group identifier, and the communication group identifier comprises the device communication identifier, to parse the control information and to generate a control instruction, and send the control instruction to a corresponding smart household device,
wherein after executing the control instruction, the smart household device sends its own status information to the smart household control apparatus, the smart household control apparatus converts the status information to the second communication information and sends the second communication information to the smart household control server, and the smart household control server sends the second communication information to a communication group corresponding to the communication group identifier.

10. The smart household control apparatus according to claim 9, wherein the first communication information and the second communication information are text information and/or voice information expressed in a manner of natural language.

11. The smart household control apparatus according to claim 10, wherein the first communication information is received from a user via a chat window displayed on an interface of the respective mobile terminal.

12. The smart household control apparatus according to claim 9, wherein the control list further comprises setting of whether a user is allowed to control the respective smart household device.

13. The smart household control apparatus according to claim 9, wherein the first communication information further comprises a user communication identifier, and the communication group corresponding to the communication group identifier comprises at least one user and at least one smart household device.

14. The smart household control apparatus according to claim 9, wherein the instruction processing module is further configured to:
inquire the control list, according to the user communication identifier and the communication group identifier, to determine whether a user corresponding to the user communication identifier is allowed to operate the respective smart household device in the communication group, and send the control instruction to the respective smart household device in the communication group that the user is allowed to operate.

15. The smart household control apparatus according to claim 9, wherein the instruction processing module is further configured to:
search, in the control list, for a smart household device associated with the smart household device according to the received status information of the smart household device, and send a preset control instruction to a found smart household device, such that the found smart household device executes the preset control instruction, and returns its own status information after execution, to the smart household control apparatus.

16. A smart household control system, wherein the system comprises: at least one mobile terminal, at least one smart household device, a smart household control server, and the smart household control apparatus according to claim 9,
wherein the at least one mobile terminal is configured to send first communication information to the smart household control server,
the smart household control server establishes a communication group comprising at least one mobile terminal and at least one smart household device, and sends the first communication information, sent from each of the at least one mobile terminal and received in the communication group, to the smart household control apparatus.

17. The smart household control system according to claim 16, wherein each of the at least one smart household device is configured to: execute a control instruction sent by the smart household control apparatus, and send its own status information to the smart household control apparatus, the smart household control apparatus converts the status information to second communication information and sends the second communication information to the smart household server, and the smart household control server sends the second communication information to a communication group corresponding to the communication group identifier.

18. The smart household control system according to claim 17, wherein the at least one smart household device is further configured to: sense, in the communication group, third communication information of members in the communication group, initiatively execute a related operation according to the third communication information, and return its own status information after execution to the communication group.

19. The smart household control system according to claim 16, wherein the first communication information and the second communication information are text information and/or voice information expressed in a manner of natural language.

20. The smart household control system according to claim 19, wherein the first communication information is received from a user via a chat window displayed on an interface of the respective mobile terminal.
